(19) United States
(12) Patent Application Publication
(10) Pub. No.: US 2018/0304902 A1
(43) Pub. Date: Oct. 25, 2018

(54) ENHANCED MESSAGE DELIVERY

(71) Applicant: Ford Global Technologies, LLC, Dearborn, MI (US)

(72) Inventors: YIFAN CHEN, Ann Arbor, MI (US); KWAKU O. PRAKAH-ASANTE, Commerce Township, MI (US); BASAVARAJ TONSHAL, Northville, MI (US); PADMA AISWARYA KOLISETTY, Chennai, Tamil Nadu (IN); HSIN-HSIANG YANG, Ann Arbor, MI (US)

(73) Assignee: Ford Global Technologies, LLC, Dearborn, MI (US)

(21) Appl. No.: 15/767,453

(22) PCT Filed: Nov. 20, 2015
(86) PCT No.: PCT/US15/61894

§ 371 Date: Apr. 11, 2018

(51) Int. Cl. B60W 40/08; G06K 9/00; B60W 50/14

(52) U.S. Cl. CPC B60W 40/08; G06K 9/00885; G06K 9/00845; G06K 2009/00939; B60W 2040/0872; B60W 2040/0818; B60W 50/14

(57) ABSTRACT

Biometric data about a vehicle occupant are received from a wearable device. Based at least in part on the biometric data, an occupant alertness and an occupant workload are determined. A rate of transmission of messages to the occupant is adjusted based at least in part on at least one of the occupant workload and the occupant alertness.

### CROSS-REFERENCE TO RELATED APPLICATIONS

This application is a national stage of, and claims priority to, Patent Cooperation Treaty Application No. PCT/US2015/061894, filed on Nov. 20, 2015, which application is hereby incorporated herein by reference in its entirety.

### BACKGROUND

Vehicle computers can generate messages for occupants, e.g., regarding faults, dangers, and/or other issues relating to vehicle operation and/or systems. However, a vehicle computer may generate messages in a short period of time, rendering the occupant unable to consider more than one, or fewer than all, of the messages.

### BRIEF DESCRIPTION OF THE DRAWINGS

FIG. 1 is a block diagram of an example system including a wearable device in a vehicle.

FIG. 2 is an example process for adjusting a rate of transmission of vehicle messages based on vehicle occupant biometric data from a wearable device.

FIG. 3 is an example process for determining adjustments to the rate of transmission of vehicle messages based on vehicle occupant biometric data.

### DETAILED DESCRIPTION

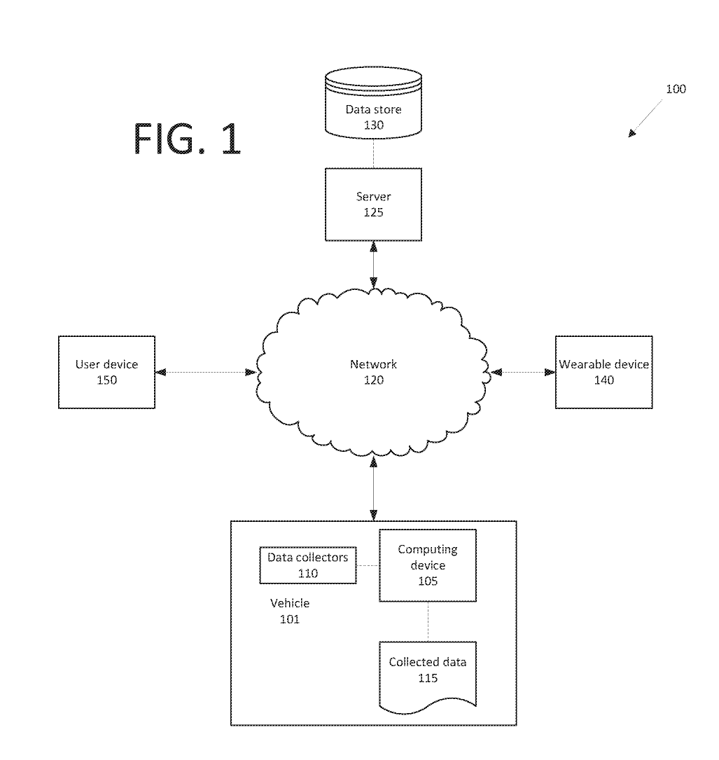

FIG. 1 illustrates a system 100 including a wearable device 140 communicatively coupled to a vehicle 101 computing device 105. The computing device 105 is programmed to receive collected data 115 from one or more data collectors 110, e.g., vehicle 101 sensors, concerning various measurements related to the vehicle 101. For example, the measurements may include biometric data related to a vehicle 101 occupant, e.g., heartbeat, respiration, pupil dilation, body temperature, skin temperature, state of consciousness, etc. Further examples of such measurements may include measurements of vehicle systems and components (e.g., a steering system, a powertrain system, a brake system, internal sensing, external sensing, etc.). The computing device 105 may be programmed to collect data 115 from the vehicle 101 in which it is installed, sometimes referred to as a host vehicle 101, and/or may be programmed to collect data 115 about a second vehicle 101, e.g., a target vehicle.

The computing device 105 is generally programmed for communications on a controller area network (CAN) bus or the like. The computing device 105 may also have a connection to an onboard diagnostics connector (OBD-II). Via the CAN bus, OBD-II, and/or other wired or wireless mechanisms, the computing device 105 may transmit messages to various devices in a vehicle and/or receive messages from the various devices, e.g., controllers, actuators, sensors, etc., including data collectors 110. Alternatively or additionally, in cases where the computing device 105 actually comprises multiple devices, the CAN bus or the like may be used for communications between devices represented as the computing device 105 in this disclosure.

Data collectors 110 may include a variety of devices. For example, various controllers in a vehicle may operate as data collectors 110 to provide data 115 via the CAN bus, e.g., data 115 relating to ambient cabin temperature, outdoor temperature, humidity, etc., of any number of vehicles 101. Sensor data collectors 110 could include RADAR, LIDAR, sonar, thermocouples, thermistors, manometers, hygrometers, etc., and/or other sensors, e.g., that could be deployed to measure climate data in the vehicle 101. Yet other data collectors 110 could include cameras, breathalyzers, skin response sensors, motion detectors, etc., i.e., data collectors 110 to provide data 115 for evaluating a condition or state of a vehicle 101 operator.

Collected data 115 may include a variety of data collected in a vehicle 101. Examples of collected data 115 are provided above, and moreover, data 115 is generally collected using one or more data collectors 110, and may additionally include data calculated therefrom in the computer 105. In general, collected data 115 may include any data that may be gathered by the data collectors 110 and/or computed from such data.

The system 100 may further include a network 120 connected to a server 125 and a data store 130. The computer 105 may further be programmed to communicate with one or more remote sites such as the server 125, via a network 120, such remote site possibly including a data store 130. The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be programmed to determine an appropriate action for one or more vehicles 101, and to provide direction to the computer 105 to proceed accordingly. The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115, records relating to potential incidents generated as described herein, lane departure profiles, etc. Further, the server 125 may store information related to particular vehicle 101 and additionally one or more other vehicles 101 operating in a geographic area, traffic conditions, weather conditions, etc., within a geographic area, with respect to a particular road, city, etc. The server 125 could be programmed to provide alerts and/or messages to a particular vehicle 101 and/or other vehicles 101.

The wearable device 140 may be any one of a variety of computing devices including a processor and a memory, as well as communication capabilities that is programmed to be worn on a driver's body. For example, the wearable device 140 may be a known device such as a watch, a smart watch, a vibrating apparatus, etc. that includes capabilities for wireless communications using IEEE 802.11, Bluetooth, and/or cellular communications protocols. The wearable device 140 may include data collectors, e.g. biometric sensors, to collect information on a vehicle 101 occupant's biometric status.

The system 100 may include the user device 150. The user device 150 may be any one of a variety of computing devices including a processor and a memory, e.g., a smartphone, a tablet, a personal digital assistant, etc. the user device 150 may communicate with the vehicle computer 105 and the wearable device 140.

The vehicle 101 may include a human machine interface (HMI). The HMI may allow an operator of the vehicle 101 to interface with the computing device 105, with electronic control units, etc. The HMI may include any one of a variety of computing devices including a processor and a memory, as well as communications capabilities. The HMI may include capabilities for wireless communications using IEEE 802.11, Bluetooth, and/or cellular communications protocols, etc. The HMI may further include interactive voice response (IVR) and/or a graphical user interface (GUI), including e.g., a touchscreen or the like, etc. The HMI may communicate with the network 120 that extends outside of the vehicle 101 and may communicate directly with the computing device 105, e.g., using Bluetooth, etc.

The computing device 105 may send messages from various vehicle 101 systems to the vehicle 101 occupant, via the vehicle 101 HMI messages may be displayed on a screen, indicated via audio output such as sounds or speech, etc. However, depending on a volume of the messages and a state of the vehicle 101 occupant, the occupant may be overloaded with information from the messages. If the occupant is not as alert as usual, or if the occupant is receiving more messages than can be understood in a given period of time, information may be lost and/or a hazardous driving condition may be created. The computing device 105 may typically transmit messages at a predetermined rate determined by, e.g., a vehicle 101 manufacturer. The rate of transmission of the messages may depend on whether the message is transmitted in response to an event (“event-based messages”), e.g. a blown tire or a traffic accident, or transmitted periodically at set periods of time (“periodic messages”), e.g. a warning sounding every 30 seconds indicating that a door is ajar. Further, messages transmitted in response to an event may be transmitted periodically following the event (“event-periodic messages”). The computing device 105 may adjust the rate of transmitting of messages based on the alertness and workload of the vehicle 101 operator.

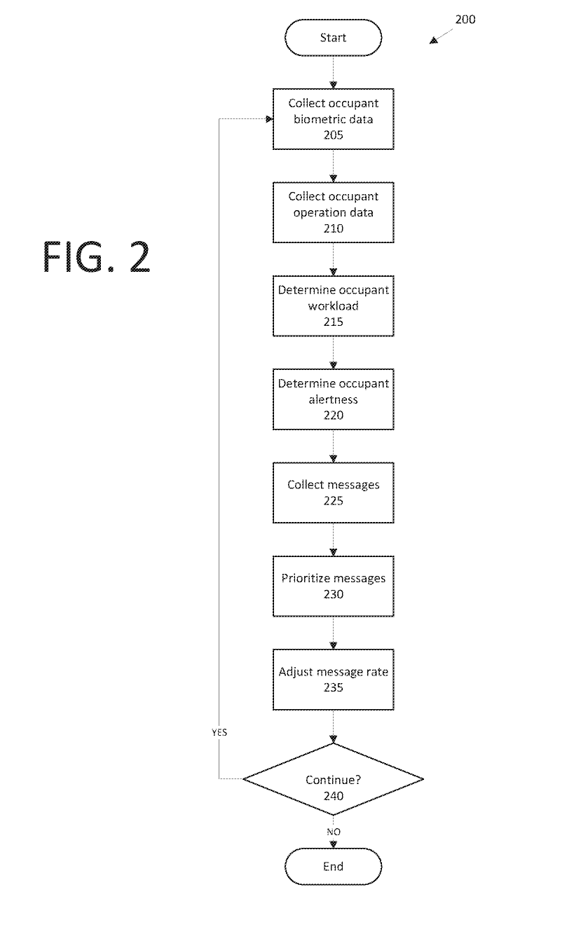

FIG. 2 illustrates an exemplary process 200 for adjusting a rate of transmission of messages to the vehicle 101 occupant. The process 200 starts in a block 205, in which the computing device 105 and/or the wearable device 140 collect biometric information from the vehicle 101 occupant. The wearable device 140 may include biometric sensors to collect data about, e.g., a vehicle 101 occupant heartbeat, skin temperature, blood pressure, electrocardiogram, etc.

Next, in a block 210, the computing device 105 collects vehicle 101 operating data, e.g., steering wheel angle, fuel level, velocity, acceleration, use of turn signals, number of turn signals, etc. The operating data may characterize the state of the vehicle 101 during operation. The operation information may come from, e.g., data 115 collected from data collectors 110, the server 125, etc.

Next, in a block 215, the computing device 105 determines an occupant workload based on the operation information. The occupant workload is a measure of the current state of the vehicle 101 occupant regarding operation of the vehicle 101, e.g., a number of tasks being performed at a particular time, possibly weighted according to the specific tasks being performed, e.g., operating an entertainment system might be weighted lower than operating a steering wheel. For example, if the occupant is performing several tasks while driving, the occupant workload may be high; similarly, if the occupant is not performing tasks, the occupant workload may be low. The workload may be, e.g., an index having a value between 0 and 1. The occupant workload is determined based on the operations performed in the vehicle 101 at a given time. The occupant workload may further include at least one of, e.g., vehicle 101 speed, headway, brake reaction time, brake jerks, steering wheel motion, traffic density, driving location, interaction with a vehicle 101 instrument panel, etc. Various known systems and methods may be used for determining an occupant workload, e.g., such are known and described in U.S. Pat. No. 8,972,106, fully incorporated herein by reference in its entirety.

The occupant workload may fall into one of three states: high, neutral, and low. The occupant workload is “high” when the occupant workload exceeds a first predetermined workload threshold, e.g. 0.8. The occupant workload is “low” when the occupant workload is below a second predetermined workload threshold, the second workload threshold being lower than the first workload threshold, e.g. 0.5. The occupant workload is “neutral” when the occupant workload is below the first workload threshold but above the second workload threshold.

Next, in a block 220, the computing device 105 determines an occupant alertness based on the biometric data collected by the wearable device 140. The occupant alertness is a measure of the attention that the occupant has based on biometric information. The occupant alertness may be “alert”, i.e. above a predetermined alertness threshold, when the biometric information indicate that the occupant is attentive, e.g., the occupant's heartbeat is steady, blood pressure is steady, etc. The occupant alertness may be “fatigued”, i.e. below the alertness threshold, when the biometric information indicate that the occupant is not fully attentive, e.g., the occupant's blood pressure drops, heartbeat slows, etc. For example, an occupant's heartbeat is typically higher when the occupant is alert, and lower when the occupant is fatigued. An occupant may, for example, exhibit a heartbeat range of 58 beats per minute (BPM) to 90 beats per minute. The relative degree of alertness for a particular occupant may be computed based on learning the heartbeat range over a period of time to form a baseline heartbeat. The baseline heartbeat may be measured and stored for evaluation to contribute to decision-making. For example, a tunable dimensionless alertness value A may be computed as follows:

$$A = \frac{CHR - MINHR}{HRR}$$

where MINHR is a minimum heartbeat, CHR is a current heartbeat such that CHR≥MHR, and HRR is a range of heartbeats, e.g. MAXHR−MINHR, where MAXHR is a maximum heartbeat, for a particular occupant. The alertness value is therefore a value between 0 and 1. Alertness values closer to 1, e.g. A≥0.7, may signify higher alertness, while alertness values closer to 0, e.g. A<0.2, may indicate fatigue. Furthermore, methods are known that the heart rate variability is composed of low frequency (0.04-0.15 Hz) and high frequency (0.15-4 Hz) components. The ration of the power spectral density of the low frequency components to the high frequency components is known to provide an alertness indicator. The ratio of the power spectral densities may be computed and tracked as another measure for relative alertness for decision-making.

Next, in a block 225, the user device 150 collects vehicle messages produced by the computing device 105 from various vehicle 101 systems. For example, the messages may be based on data 115 from one or more vehicle 10 systems, e.g., an engine, a powertrain, tire pressure sensors, gas tank sensors, etc., and/or from messages or data from the server 125. The computing device 105 and/or the user device 150 may designate some of the messages as user-facing messages, i.e., messages that may be sent to a vehicle 101 occupant for interaction with the occupant. Such user-facing messages include, e.g., vehicle 101 system information, entertainment information, safety information, diagnostic or malfunction information, etc.

Next, in a block 230, the user device 150 prioritizes the messages. The computing device 105 may be programmed with a preset prioritization determined, e.g., by a vehicle 101 and/or device 105 manufacturer, and the user device 150 may receive the prioritization from the computing device 105. The prioritization ranks each message, with messages identified as messages that should be addressed immediately ranking higher than messages providing information to which a delayed response is acceptable. For example, a message from a vehicle 101 engine indicating an overheating engine, which may require immediate attention, could be ranked higher than a message from a phone call coming into the user device 150. Similarly, the phone call may have a higher rank than a message from a vehicle 101 entertainment system indicating that a particular song is about to be played. In general, messages related to diagnostic systems (e.g. overheating engine, low gasoline, low tire pressure, etc.) rank higher than communicative messages (e.g. phone calls, text messages, etc.), both of which rank higher than entertainment messages (e.g. a preferred song, a show on a particular radio station, etc.). The user device 150 may selectively prioritize messages marked as user-facing messages by the computing device 105. Alternatively, the computing device 105 may prioritize the plurality of messages.

Next, in a block 235, the user device 150 adjusts a rate of transmission of messages based on the occupant alertness and workload. The adjustment is described in the process 300 below.

Next, in a block 240, the computing device 105 determines whether to continue collecting data to adjust the rate of transmission of messages to the occupant. If so, the process 200 returns to the block 205 to collect more data. Otherwise, the process 200 ends.

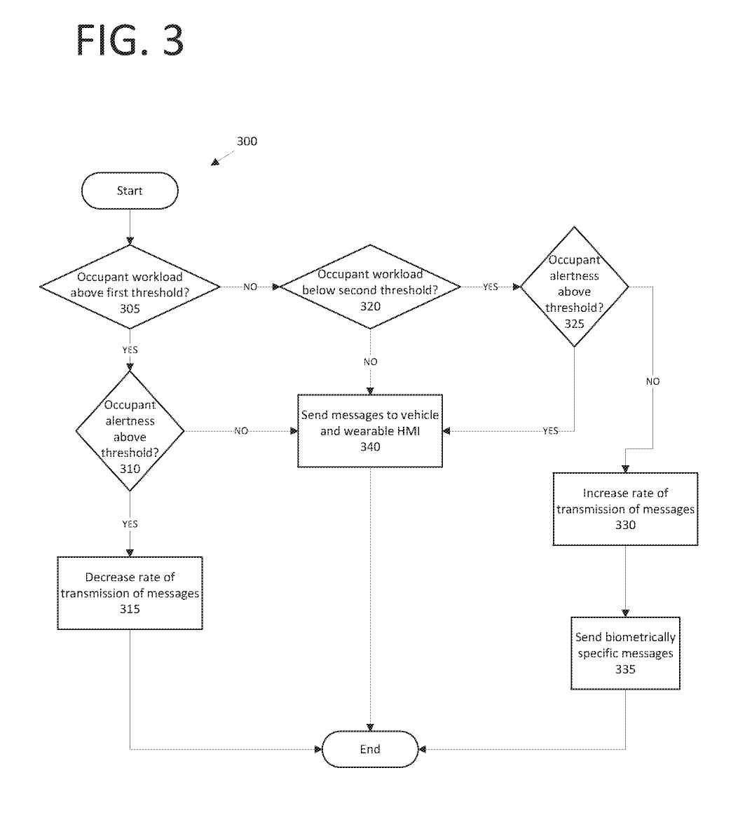

FIG. 3 illustrates a process 300 for determining the adjustment of the rate of transmission of messages as described in the block 235 of the process 200 above. The process 300 starts in a block 305 where the computing device 105 sends the determination of the occupant's alertness and workload to the user device 150. The user device 150 then determines if the occupant has a high workload. If so, the process 300 continues in a block 310. Otherwise, the process 300 moves to a block 320.

In the block 310, the user device 150 determines whether the occupant's alertness level exceeds the alertness threshold. If the occupant's alertness exceeds the predetermined threshold, and the occupant has a high workload, the user device 150 may reduce the number of messages that the occupant must address, and the process 300 moves to the block 315. Otherwise, the occupant's alertness is below the threshold, i.e. fatigued, and the process 300 moves to a block 340.

In the block 315, the user device 150 decreases the rate of transmission of messages to the occupant, and the process 300 ends. For example, the user device 150 may transmit only high priority messages, as determined in the block 230 of the process 200 above, and/or may present the messages at a rate slower than the typical rate of transmission of messages. The user device 150 may also decrease the rate of periodic messages, e.g., increasing the period of time between transmission of each periodic message, e.g., from 5 seconds to ten seconds. For event-based messages, the user device 150 may delay or suppress low priority event-based messages, and send only the highest priority messages. For event-periodic messages, low priority messages may be delayed or suppressed, and for those event-periodic messages that are transmitted, the period between transmission of each periodic message may increase.

In the block 320, the user device 150 determines whether the occupant workload is below the second workload threshold, i.e., the workload is low. If the occupant workload is below the second workload threshold, the process 300 continues in a block 325. Otherwise, the process 300 moves to the block 340.

In the block 325, the user device 150 determines whether the occupant alertness is above the alertness threshold, i.e. the occupant is alert. If the occupant alertness is above the alertness threshold, the process 300 moves to the block 340. Otherwise, the process 300 continues in a block 330.

In the block 330, the user device 150 increases the rate of transmission of messages. The user device 150 may, e.g., decrease the period for periodic and event-periodic messages. The user device 150 may transmit event-based messages that may have been suppressed or delayed based on their low priority. Because the occupant has a low workload and is fatigued, the user device 150 transmits more messages to cause the occupant to perform more tasks, increasing their workload and/or their alertness. Furthermore, the user device 150 provide an instruction to the wearable device to actuate one or more outputs on the wearable device 140 and/or the vehicle HMI. The outputs may include haptic output, e.g. a vibration, audio output, and/or visual output, e.g. flashing lights, flashing colors, etc. The instruction may direct the wearable device 140 to actuate different outputs depending on the prioritization of the message. For example, a high priority message may include actuation of both haptic and audio outputs, while a low priority message may use only one of a haptic and an audio outputs. The output may cause the occupant to perform enough tasks to transition above the second workload threshold and/or to an alertness exceeding the alertness threshold. Furthermore, the user device 150 may transmit more messages to the wearable device 140 to increase the occupant's alertness.

Next, in a block 335, the user device 150 transmits at least one personalized message based on the biometric information to the occupant on the wearable device 140 and/or the vehicle 101 HMI, and the process 300 ends. For example, because the occupant is fatigued, a message with, e.g., an image of a coffee cup may be sent to encourage the occupant to take a break from driving.

In the block 340, the user device 150 transmits messages to the wearable device 140 and/or the vehicle 101 HMI at the predetermined rate described above, being the rate typically used by the computing device 105 without biometric data, and the process 300 ends. That is, the user device 150 will not increase or decrease the rate of transmission of messages compared to the rate programmed in the computing device 105. The user device 150 may, however, transmit the messages to one of the wearable device 140 and the vehicle 101 HMI based on the occupant alertness and workload. For example, if the occupant alertness is above the alertness threshold and the workload is below the second workload threshold, the user device 150 may send messages to the vehicle 101 HMI, where the occupant may have more time and/or attention to address them. Similarly, if the occupant alertness is below the alertness threshold and the workload is above the first workload threshold, the user device 150 may send more messages to the wearable device 140, rather than the vehicle 101 HMI, where the occupant may address the messages more quickly and/or increase their alertness.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 200, one or more of the steps could be omitted, or the steps could be executed in a different order than shown in FIG. 2. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system, comprising a computer including a processor and a memory, the memory storing instructions executable by the computer to:
receive biometric data about a vehicle occupant from a wearable device;
based at least in part on the biometric data, determine an occupant alertness and an occupant workload; and
adjust a rate of transmission of messages to the occupant based at least in part on at least one of the occupant workload and the occupant alertness.

2. The system of claim 1, wherein the instructions further include instructions to decrease the rate of message transmission when the occupant workload is above a first workload threshold.

3. The system of claim 1, wherein the instructions further include instructions to increase the rate of message transmission when the occupant workload is below a second workload threshold and the occupant alertness is below an alertness threshold.

4. The system of claim 3, wherein the instructions further include instructions to send a personalized message based on the biometric data when the occupant alertness is below the alertness threshold.

5. The system of claim 1, wherein the instructions include instructions to actuate an output on the wearable device based on the message.

6. The system of claim 1, wherein the instructions further include instructions to prioritize the messages and to suppress low priority messages when the occupant workload is above a first workload threshold.

7. The system of claim 1, wherein the instructions further include instructions to adjust the rate of transmission of the messages in a user device, the user device configured to transmit the messages to at least one of the wearable device and a vehicle human machine interface.

8. The system of claim 7, wherein the instructions further include instructions to transmit the messages to the wearable device when the occupant alertness is below an alertness threshold.

9. The system of claim 7, wherein the instructions further include instructions to transmit the messages to the vehicle human machine interface when the occupant alertness is above an alertness threshold and the occupant workload is below a second workload threshold.

10. The system of claim 1, wherein the biometric data include at least one of heartbeat, blood pressure, skin temperature, and electrocardiogram.

11. A method, comprising:
receiving biometric data about a vehicle occupant from a wearable device;
based at least in part on the biometric data, determining an occupant alertness and an occupant workload; and
adjusting a rate of transmission of messages to the occupant based at least in part on at least one of the occupant workload and the occupant alertness.

12. The method of claim 11, further comprising decreasing the rate of message transmission when the occupant workload is above a first workload threshold.

13. The method of claim 11, further comprising increasing the rate of message transmission when the occupant workload is below a second workload threshold and the occupant alertness is below an alertness threshold.

14. The method of claim 13, further comprising sending a personalized message based on the biometric data when the occupant alertness is below the alertness threshold.

15. The method of claim 11, further comprising actuating an output on the wearable device based on the message.

16. The method of claim 11, further comprising prioritizing the messages and suppressing low priority messages when the occupant workload is above a first workload threshold.

17. The method of claim 11, further comprising adjusting the rate of transmission of the messages in a user device, the user device transmitting the messages to at least one of the wearable device and a vehicle human machine interface.

18. The method of claim 17, further comprising transmitting the messages to the wearable device when the occupant alertness is below an alertness threshold.

19. The method of claim 17, further comprising transmitting the messages to the vehicle human machine interface when the occupant alertness is high and the occupant workload is below a second workload threshold.

20. The method of claim 11, wherein the biometric data include at least one of heartbeat, blood pressure, skin temperature, and electrocardiogram.
